(19) United States
(12) Patent Application Publication
(10) Pub. No.: US 2011/0031792 A1
(43) Pub. Date: Feb. 10, 2011

(54) LOWER PELVIC CORNER SUPPORT DEVICE FOR AUTOMOTIVE RECLINER SEAT

(75) Inventor: Xi Sun, Overland Park, KS (US)

Correspondence Address: Xi Sun, 7529 W. 143rd Terrace, Overland Park, KS, 66223, US

(73) Assignee: Xi Sun, Overland Park, KS (US)

(21) Appl. No.: 12/538,112

(22) Filed: Aug. 8, 2009

(51) Int. Cl. B60N 2/66; A47C 7/46; A47C 7/42

(52) U.S. Cl. 297/284.5; 297/284.4

(57) ABSTRACT

The present invention pertains to an automotive recliner seat support device to provide a dynamic support for a driver's foot-leg-hip axis at its lower pelvic end to ease the driver's muscle stress from lower limbs to upper back when the driver is using his/her lower limbs to push the clutch and/or brake pedals in performing normal and emergency driving operations of a vehicle. Two preferred embodiments of the invention are disclosed. The first one is an attachable device intended to retrofit to the existing vehicle seats; whereas the second one is integrated into the seat structure, and is intended to be built into future vehicles.

### FIELD OF THE INVENTION

The present invention pertains in general to a support device for vehicle seats which helps occupants feel less stress. More particularly, the invention relates to a device for providing a dynamic support for an automotive driver's foot-leg-hip axis at its lower pelvic end when the driver is using his/her lower limbs to push the clutch and/or brake pedals in performing normal and emergency driving operations of a vehicle in order to ease the driver's muscle stress from lower limbs to upper back.

### BACKGROUND OF THE INVENTION

There has been an ongoing strive in building and modifying a vehicle seat to reduce an occupant's fatigue and body stress. Currently, the most common automotive driver seat is a recliner having separate seat portion and backrest portion with the two portions being securely hinged. Most prior art in the field was focused either on the seat portion or on the backrest portion in accommodating the contour of the body part of an occupant that each portion directly contacts and supports, i.e., the prior art on backrest device mostly focused on accommodating the body contour of an occupant's spine region, while that on seat device mostly focused on accommodating the body contour of an occupant's hip and legs, left the junction area that overlaps the two portions largely neglected. Among the few prior art that was involved in modifying this particular area, U.S. Pat. No. 5,975,636 was teaching a fluid supply and bladder assembly to fill the void between a passenger recliner's seat portion and the backrest in order to define a substantially continuous support surface when the backrest is in the reclined position, i.e., a substantially horizontal position for sleeping or resting; while U.S. Pat. No. 2,855,986 disclosed a seat cushion device that basically had a similar contour to the seat but had a recess section in sacral area to relieve pressure from the area. Separately, U.S. Pat. No. 5,906,413 discloses a car seat cover cushion. A sizable soft resilient cylindrical pillow attached to the cover was placed along the reclining corner of the seat in one of its configurations, the intention was “on the lower surface area of the user's back,” i.e., as a lower back cushion against the lower portion of a car seat backrest “to make the passenger feel comfortable.”

Furthermore, except a few prior art engaged in analyzing an occupant's passive inertia body movement caused by collision or braking, vast majority of the prior art in vehicle seat device was focused on accommodating an occupant's body contour in a stationary sitting position. This focus may be appropriate in considering a device for non-driving passenger seats; whereas for drivers seats, such a narrow focus might have missed critical aspects. It is true that for most time of a driving experience, a driver would be just sitting in a seat without drastic body or limb movements, very much similar to a passenger in terms of dynamics the body interacts with the seat. However, as a driver, there are times when he/she has to engage his/her whole lower limbs to push the clutch and/or brake pedals forward/downward in performing normal and emergency driving operations of a vehicle, resulting in a quite different dynamics the body interacts with the seat although in short durations.

A lack of such perspective in prior art has practically left the lower pelvic region unsupported for most drivers. This is manifested by the fact that there is an empty space behind the lower pelvic region immediately on and above a substantially flat seat cushion in that area for most drivers when sitting in a recliner seat of current common design in a natural driving position. An unsupported lower pelvic region may not generate extra stress on a driver's lower back or hip when the driver is just sitting in the seat since in a driving position, the backrest of the recliner is normally in a slightly angular orientation from its upright position, and the driver's upper body weight falls largely onto the seat portion in the hip area and partially on the backrest in the lumber area and above; there is no weight needs to be supported from the seat's reclining corner for the driver's lower pelvic region. However, when the driver is using his/her lower limbs to push the clutch and/or brake pedals, an unsupported lower pelvic region may cause extra stress on the driver's body muscles; and this is particularly the case for the drivers of automotive vehicles with manual transmission, i.e., with a clutch pedal.

The manufacturers of manual transmission vehicles normally recommend users to push the clutch pedal all way down to the wall in order to disengage the clutch; many of these pedals have significant resistance. When a driver is pushing the pedal forward/downward using muscles along his/her foot-leg-hip axis, by nature the body will seek support from behind in a direction against the backrest. The most efficient support would come from the lower pelvic region since it is right at the other end of the driver's foot-leg-hip axis opposite to the foot end where it is pushing against the pedal. Since the driver's body bends at the lower pelvic region along the seat's reclining corner, an unsupported lower pelvic region would naturally lead the body to seek supports upwards in the lumbar or even up to the thoracic and shoulder areas against the backrest, causing extra stresses to the driver's body muscles ranging from lower limbs all way to upper back.

A seemingly easy solution to this problem would be to adjust the position of the entire driver seat one or two notches closer to the pedals so that the driver does not have to fully extend his/her lower limbs to push the pedals to their possible ends. Such a move would give a driver some degree of ease since it would allow the driver to use their lower limb muscles more efficiently in pushing the pedals, but at the expense of having less leg rooms for the driver with a particular vehicle, which in turn would cause fatigue to the driver in his/her driving experiences. Therefore, drivers, particularly those of manual transmission vehicles, have to make a choice, either consciously or unconsciously, between dilemmas.

In view of the above-discussed problems, there is a need in the art to provide a device which would help drivers to avoid such a dilemma.

### BRIEF SUMMARY OF THE INVENTION

The principle object of present invention is to provide a device for vehicle recliner seat of current common design in receiving an occupant's lower pelvic region from under and behind. More particularly, the device is for driver seat and for providing a dynamic support for a driver's foot-leg-hip axis at its lower pelvic end when the driver is using his/her lower limbs to push the clutch and/or brake pedals in performing normal and emergency driving operations of a vehicle in order to ease the driver's muscle stress from lower limbs to upper back.

Another object of the present invention is to provide a support device that is simple to manufacture and dispose, having simple means for adjusting itself to fit for users with a range of body size, and being able to retrofit to most existing vehicle's recliner seats.

A further object of the present invention is to provide a safe device with attaching means for securing itself to a vehicle seat.

Still a further object of the present invention is to provide a modified vehicle seat that incorporates said device into its structure, enabling vehicle seat manufacturers to build more comfortable seats for future vehicles.

According to the broad principles of the present invention, a support device comprises a resilient main body with an elongated configuration disposed partially under and partially behind a driver's lower pelvic region; when engaged, the device forms a concaved longitudinal surface in receiving the driver's lower pelvic region and provides a corner support for a driver's foot-leg-hip axis at its lower pelvic end when the driver is using his/her lower limbs to push the clutch and/or brake pedals. Such a dynamic support helps to ease the driver's body muscle stress ranging from lower limbs to upper back in performing such driving operations, yet without compromising the driver's leg room with the vehicle he/she is driving.

Two preferred embodiments of the device are disclosed in the present invention. The first embodiment is in the form of an attachable device. The device is simple to make and easy to dispose, and has some degree of adjustability to adapt itself to people in a range of body sizes and in favor of slightly different reclining angles. In the second embodiment, the device is incorporated into the structure of a vehicle's recliner seat, enabling vehicle seat manufacturers to build more comfortable recliner seats for future vehicles.

In summary, the present invention differentiates from the prior art in the field in that:
1) The device from present invention is disposed partially under and partially behind a user's pelvic region along the seat's reclining corner, where the bottom edge of the seat's backrest approaches the rear edge of the seat cushion, to provide a corner support for the user's said body part;
2) The present invention is primarily dedicated to drivers, including those normal and healthy, for supporting their normal and emergency driving operations that involve their lower limbs;
3) The present invention is for providing a dynamic support for a driver's foot-leg-hip axis when the driver is using his/her lower limbs to push the clutch and/or brake pedals;
4) Such a dynamic support helps to ease the driver's body muscle stress far reaching from the local body part or area that is in direct contact or adjacent to the device, ranging from lower limbs to upper back.

### BRIEF DESCRIPTION OF THE SEVERAL VIEWS OF THE DRAWING

FIG. 1 is a schematic, side elevation view of a driver sitting in a vehicle recliner seat with his lower limb stepping on the clutch pedal to illustrate the empty space behind the driver's lower pelvic area and the driver's foot-leg-hip axis in performing such a driving operation.

FIG. 2 is a similar view of FIG. 1, illustrating the general principle of the present invention.

FIG. 3 is a perspective view of a preferred embodiment of the device by the present invention.

FIG. 4 is a cross sectional view of the device's main body along the line 4-4 of FIG. 3.

FIG. 5 is a perspective view of the corner support device being securely attached to a seat in illustration of the attaching mechanism.

FIG. 6 is a schematic, side elevation view of another preferred embodiment of the present invention, in which the device is incorporated into the seat cushion.

### DETAILED DESCRIPTION OF THE INVENTION

While this invention is susceptible of embodiment in many different forms since various materials with different deformability can be chosen to build this device and serve the function disclosed herein, two specific embodiments of the present invention will be shown in the drawings and described in details in the present disclosure. They should be considered as an example of the principles of the present invention.

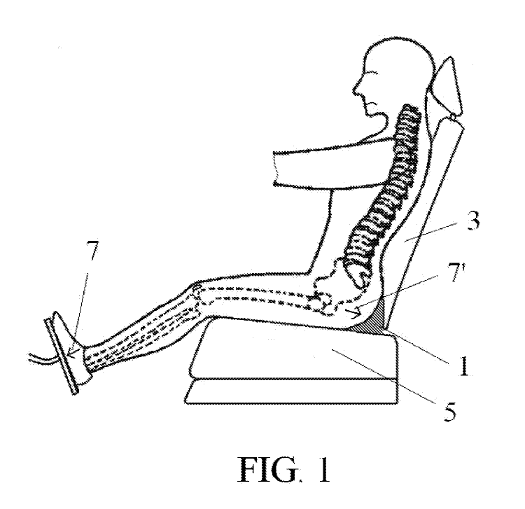

FIG. 1 is a schematic side view of a driver sitting in a recliner vehicle seat of current common design and using his/her lower limb to push a pedal, particularly with his/her left side lower limb stepping on the clutch pedal. It illustrates the empty space 1 behind a driver's lower pelvic region marked in grey. The border of the empty space 1 is defined by the driver's bodyline in the lower pelvic region and the seat's reclining corner where the bottom edge of its backrest 3 approaches the rear edge of its seat cushion 5. The arrows 7 & 7′ indicate the two ends of the driver's foot-leg-hip axis and the directions that each end pushes against during such an action. The most efficient dynamic support from the seat for the driver's action should be right at the corner immediately behind the driver's lower pelvic as indicated by arrow 7′. As the driver's body bends in the lower pelvic region along the seat's reclining corner, an unsupported lower pelvic region at the reclining corner area would naturally lead the body to seek support upwards in the lumbar or even up to the thoracic and shoulder areas against the seatback, causing extra stresses to the driver's body muscles ranging from lower limbs all way to upper back.

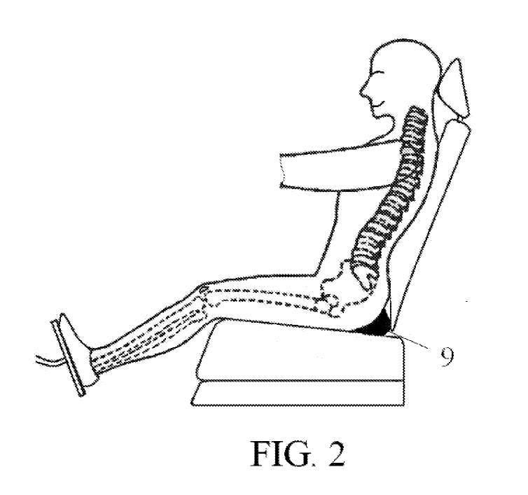

FIG. 2 illustrates the general principle of the present invention. It is different from FIG. 1 in that a support device 9 is disposed into the empty space behind the driver's lower pelvic region. The engaged device has a concaved surface in receiving the driver's lower pelvic region from under and behind. The device is against the seat's reclining corner in supporting the driver's foot-leg-hip axis at its lower pelvic end when the driver is engaged in such a driving operation. The dynamic support provided by the device will help the driver in reducing the body muscle stress ranging from lower limbs to the upper back without compromising his/her leg rooms with a particular vehicle.

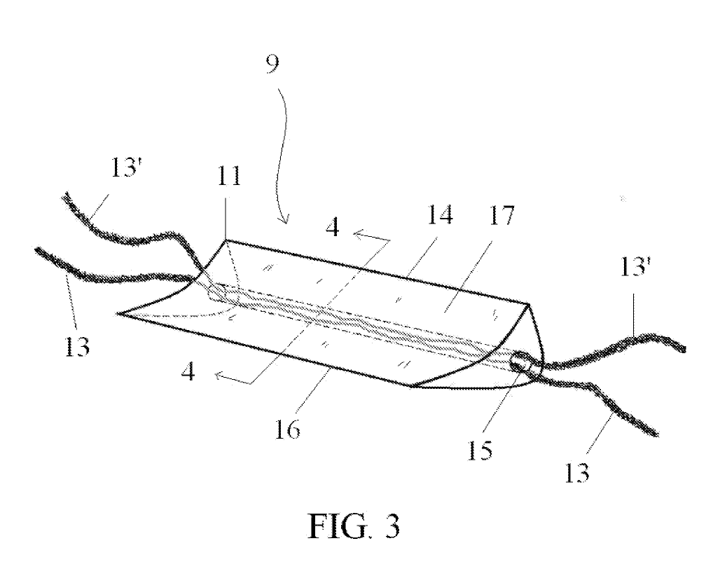

FIG. 3 is a perspective view of the first preferred embodiment of the device 9, comprising a main body 11 and two fabric cords 13 and 13′. The main body 11 is made of a resilient material, preferably rubberized plastic foam, as familiar to those skilled in the art; and has an elongated configuration that would cover at least half of a driver's body width in the lower pelvic region. The main body 11 also has a concaved longitudinal surface 17 bordered by edges 14 and 16. It is adapted for receiving the driver's lower pelvic region from under and behind. Cords 13 and 13′ comprise the attaching means for securing the device to the seat. Both pass through a circular tunnel 15, which is across the main body 11 along its longitudinal axis, and are extended on both sides. The position and diameter of the circular tunnel 15 within the main body 11 will be controlled during manufacturing process as a means for adjusting the firmness of the main body.

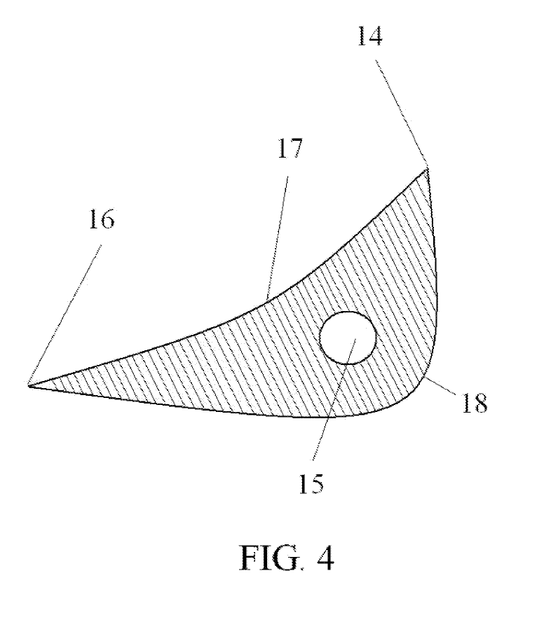

FIG. 4 is cross sectional view of the main body 11 along line 4-4 of FIG. 3. It is shaped like an asymmetrical convexo-concave eye with two edges 14 and 16. The concaved surface 17 is to receive the user's lower pelvic region from under and behind in forming a corner support. The asymmetrical shaped eye provides a choice for the user to better fit the device for his/her body part simply by flipping the device upside down. In this preferred embodiment, the convex surface 18 of the main body 11 that is to rest against the seat's reclining corner provides a feature to allow the device fit for the reclining corner with the backrest in a range of reclining positions that a driver would choose.

The main body of the device can also be made of other materials or combination of materials, such as an inflatable bladder, encased deformable beads, or a hybrid of foam-air or beads-air, as known to those skilled in the art. Depending on the deformability of a particular material or materials, the shape of an unengaged embodiment of the device may vary and may not be critical as long as it would be deformed into the shape when engaged by a user and serve the functions as disclosed herein.

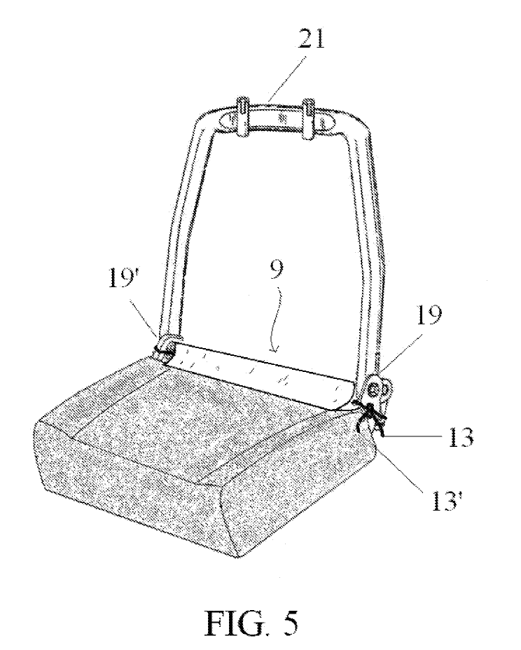

FIG. 5 is a perspective view of the device 9 being securely fastened to the recliner's side posts 19 and 19′ by the fabric cords 13 and 13′ on each side of the seat. The cushion is removed from the seat's backrest frame 21 in facilitating an illustration of the attaching mechanism of the device. Securing the device to vehicle seat is not just for comfort and convenience, but also for safety reasons. Letting the device float around the driver chamber could cause significant hazard to driving safety.

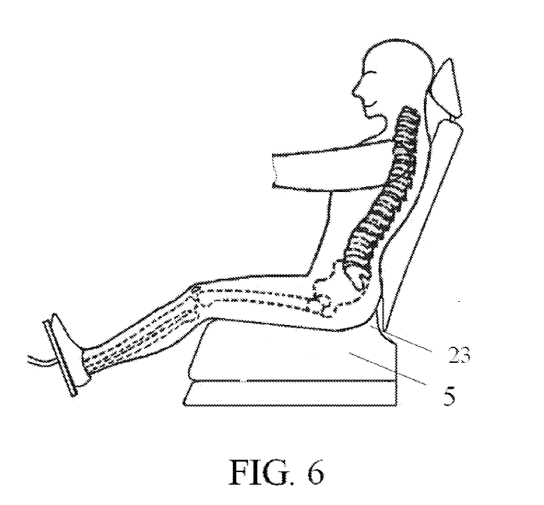

FIG. 6 is a schematic, side elevation view of a driver sitting in a modified driver seat in illustration of another preferred embodiment of the device. A bump 23 arises above an otherwise flat seat cushion 5 along the driver's lower pelvic body contour similar to that of the first embodiment of the device as illustrated in FIG. 2. The major difference of the two embodiments lies in that the device in this embodiment is incorporated into the seat cushion as part of its unitary unit. On the other hand, the longitudinal surface of the bump 23 that engages the driver's body part is also in a concaved shape when engaged and forms a corner support to receive the driver's lower pelvic region from under and behind and to serve the function as disclosed herein.

I claim:

1. A vehicle recliner seat support device comprising a main body disposed partially under and partially behind an occupant's lower pelvic region immediately on and arising above an otherwise substantially flat seat cushion in forming a corner support for the occupant's said body part.

2. The support device of claim 1 wherein said main body is resilient and in an elongated configuration; when engaged by an occupant, has a concaved longitudinal surface in receiving the occupant's lower pelvic region from under and behind to form a corner support for the occupant's said body part against the seat's reclining corner where the bottom edge of the seat's backrest approaches the rear edge of its seat cushion.

3. The support device of claim 2 wherein said main body is adapted for receiving a driver's lower pelvic region from under and behind to provide a dynamic support for the driver's foot-leg-hip axis at its lower pelvic end against the seat's reclining corner when the driver is using his/her lower limbs to push the clutch and/or brake pedals in performing normal and emergency driving operations of a vehicle.

4. The support device of claim 3 wherein the shape and dimension of said main body is adapted and limited in a way that when engaged in its best fit mode by a driver in his/her natural driving position, said element shall not push the driver's lumbar area away from, if otherwise supported by, the seat's backrest.

5. The support device of claim 3 wherein said device is portable comprising an attaching means thereon for securing said device to a part of a vehicle recliner seat and kept said device in a position desired by the user.

6. The support device of claim 3 wherein said main body is incorporated into the structure of a driver's recliner seat.
